(19) United States
(12) Patent Application Publication
(10) Pub. No.: US 2007/0028886 A1
(43) Pub. Date: Feb. 8, 2007

(54) Baffle plate configuration of internal combustion engine

(75) Inventors: Toru Obayashi, Toyokawa-shi (JP); Hiroaki Kawahara, Toyota-shi (JP); Toshiyuki Goto, Toyota-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/485,311

(22) Filed: Jul. 13, 2006

(30) Foreign Application Priority Data
Aug. 3, 2005 (JP) 2005-225250

(51) Int. Cl. F02F 7/00; F01M 11/00

(52) U.S. Cl. 123/195 C; 123/196 R

(57) ABSTRACT

A baffle plate configuration of an internal combustion engine according to a first embodiment of the invention is provided below a rotational member arranged on or near a crankshaft and prevents the rotational members and lubricant in a pan from interfering each other. The baffle plate includes a preventing portion that is provided at an end portion of the baffle plate located in the side that is opposite, in the axial direction of the crankshaft, to the side where a larger amount of lubricant returns to the pan. The preventing portion prevents piston pumping air generated above the baffle plate from entering a space below the baffle plate through the end portion of the baffle plate.

### INCORPORATION BY REFERENCE

The disclosure of Japanese Patent Application No. 2005-225250 filed on Aug. 3, 2005 including the specification, drawings and abstract is incorporated herein by reference in its entirety.

### BACKGROUND OF THE INVENTION

1. Field of the Invention

The invention generally relates to a baffle plate configuration of an internal combustion engine, more particularly, to a baffle plate configuration of an internal combustion engine that prevents adverse effects on a flow of lubricant in a pan caused by piston pumping air generated above the baffle plate.

2. Description of the Related Art

A technology in which a baffle plate is provided to separate rotational members arranged on or near a crankshaft, for example, connecting rods, from lubricant in a pan is disclosed in Japanese Utility Model Application Publication No. JP-U-5-7917. It is an object of the technology to prevent the rotational members and lubricant from interfering each other.

Piston pumping air (that is, blowby gas) generated above the baffle plate tends to enter the pan through the end of the baffle plate in one side of the crankshaft in the axial direction thereof, which is opposite to the other side where, owing to some structural reason such as a timing chain being provided therein, a large amount of lubricant returns to the pan. This tendency becomes stronger as the displacement of the internal combustion engine becomes larger, because the amount of piston pumping air accordingly increases. In this case, the lubricant that is returning to the pan through the baffle plate in the one side of the crankshaft collides with the piston pumping air that is entering the pan through the baffle plate in the other side of the crankshaft. Therefore, the lubricant cannot smoothly return to the pan.

Further, in terms of protection of pedestrians and arrangement of accessories, it is preferable that the overall height of an engine be reduced by reducing the height of the shallow depth portion of a pan. However, when the overall height of the engine is thus reduced, it is more likely that lubricant returning to the pan through the baffle plate in the one side of the crankshaft collides with piston pumping air entering the pan through the baffle plate in the other side of the crankshaft. In consideration of this, a technology that enables lubricant to return smoothly to the pan has been desired.

Moreover, when piston pumping air enters the pan through the baffle plate in the other side of the crankshaft, the following problems, for example, arise: (1) lubricant is further quickly deteriorated as a result of being stirred by the piston pumping air entering the pan; (ii) the temperature of the lubricant increases; (iii) the amount of lubricant that is atomized by the collision between lubricant and piston pumping air and then taken away by the piston pumping air increases; and (iv) the ratio of air bubbles in lubricant increases.

### SUMMARY OF THE INVENTION

A baffle plate configuration of an internal combustion engine according to a first aspect of the invention is provided below a rotational member arranged on or near a crankshaft and includes a baffle plate for preventing interference between the rotational members and lubricant in a pan. The baffle plate configuration also includes a preventing portion that is provided at an end portion of the baffle plate located in the side that is opposite, in the axial direction of the crankshaft, to the side where a larger amount of lubricant returns to the pan, and that prevents piston pumping air generated above the baffle plate from entering the space below the baffle plate through the end portion of the baffle plate.

According to this structure, piston pumping air generated above the baffle plate is prevented from entering the space below the baffle plate through the end portion thereof located in the side that is opposite, in the axial direction of the crankshaft, to the side where a larger amount of lubricant returns to the pan. As a result, collisions between lubricant returning to the pan through the baffle plate from the side of a larger amount of returning lubricant and piston pumping air entering the pan through the baffle plate from the opposite side can be prevented, so that the lubricant can smoothly return to the pan.

Further, since collisions between lubricant and piston pumping air can be prevented as described above, it is possible to reduce the height of a shallow depth portion of the pan and thus the overall height of the engine, which is significantly desirable and advantageous in view of the protection of pedestrians and arrangement of accessories, for example. Moreover, since piston pumping air is prevented from entering the pan as described above, lubricant is not stirred by piston pumping air. This suppresses deterioration of lubricant and an increase of the temperature of lubricant. In addition, the amount of lubricant which is atomized due to collision with piston pumping air and then carried away by the piston pumping air is reduced. Also, the ratio of air bubbles contained in lubricant can be reduced.

A baffle plate configuration of an internal combustion engine according to a second aspect of the invention prevents a rotational member arranged on or near a crankshaft and lubricant in a pan from interfering each other. The baffle plate configuration includes a chain that is provided at an end portion of the crankshaft located in one side in the axial direction of the crankshaft and transmits rotation of the crankshaft. The baffle plate configuration further includes a preventing portion that is provided at an end portion of the baffle plate located in the side that is opposite, in the axial direction of the crankshaft, to the side where the chain is provided, and that prevents piston pumping air generated above the baffle plate from entering the space below the baffle plate through the end portion of the baffle plate.

According to this structure, piston pumping air generated above the baffle plate is prevented from entering the space below the baffle plate through the end portion thereof located in the side that is opposite, in the axial direction of the crank shaft, to the side where the chain that transmits rotation of the crankshaft is provided. As a result, lubricant returning to the pan through the baffle plate from the side where the chain is provided is prevented from colliding with piston pumping air entering the pan through the baffle plate from the opposite side, so that the lubricant can smoothly return to the pan.

Further, since collisions between lubricant and piston pumping air can be prevented as described above, it is possible to reduce the height of a shallow depth portion of the pan and thus the overall height of the engine, which is significantly desirable and advantageous in view of the protection of pedestrians and arrangement of accessories, for example. Moreover, since piston pumping air is prevented from entering the pan as described above, lubricant is not stirred by piston pumping air. This suppresses deterioration of lubricant and an increase of the temperature of lubricant. In addition, the amount of lubricant which is atomized due to collision with piston pumping air and then carried away by the piston pumping air is reduced. Also, the ratio of air bubbles contained in lubricant can be reduced.

A baffle plate configuration of an internal combustion engine according to a third aspect of the invention prevents a rotational member arranged on or near a crankshaft and lubricant in a pan from interfering each other. The baffle plate configuration includes a shallow depth portion that is formed in one side in the axial direction of the crankshaft and has a shallow depth. The baffle plate configuration includes a preventing portion that is provided at an end portion of the baffle plate located in the side that is opposite, in the axial direction of the crankshaft, to the side where the shallow depth portion is provided, and that prevents piston pumping air generated above the baffle plate from entering the space below the baffle plate through the end portion of the baffle plate.

According to this structure, piston pumping air generated above the baffle plate is prevented from entering the space below the baffle plate through the end portion thereof located in the side that is opposite, in the axial direction of the crank shaft, to the side where the shallow depth portion is provided. As a result, lubricant returning to the pan through the baffle plate and the shallow depth portion is prevented from colliding with piston pumping air entering the pan through the baffle plate from the opposite side, so that the lubricant can smoothly return to the pan.

Further, since collisions between lubricant and piston pumping air can be prevented as described above, it is possible to reduce the height of the shallow depth portion of the pan and thus the overall height of the engine, which is significantly desirable and advantageous in view of the protection of pedestrians and arrangement of accessories, for example. Moreover, since piston pumping air is prevented from entering the pan as described above, lubricant is not stirred by piston pumping air. This suppresses deterioration of lubricant and an increase of the temperature of lubricant. In addition, the amount of lubricant which is atomized due to collision with piston pumping air and then carried away by the piston pumping air is reduced. Also, the ratio of air bubbles contained in lubricant can be reduced.

A baffle plate configuration of an internal combustion engine according to a fourth aspect of the invention is provided below a rotational member arranged on or near a crankshaft, and prevents the rotational member and lubricant in a pan from interfering each other. The baffle plate includes a preventing portion that is provided at an end portion of the baffle plate located in the side that is opposite, in the axial direction of the crank shaft, to the side where the crankshaft protrudes from a crankcase that houses the rotational member, and that prevents piston pumping air generated above the baffle plate from entering the space below the baffle plate through the end portion of the baffle plate.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a cross-sectional view in which a lower portion of a V-engine according to an embodiment of the invention is viewed from a side of a vehicle.

FIG. 2 is a front view in which the V-engine is viewed from a front side in an axial direction of a crankshaft.

FIG. 3 is a plan view of a baffle plate that is attached to a pan viewed from above.

FIG. 4 is a rear view of the V-engine viewed from a rear side in the axial direction of the crankshaft.

### DETAILED DESCRIPTION OF THE PREFERRED EMBODIMENTS

In the following description, the invention will be described in more detail in terms of exemplary embodiments.

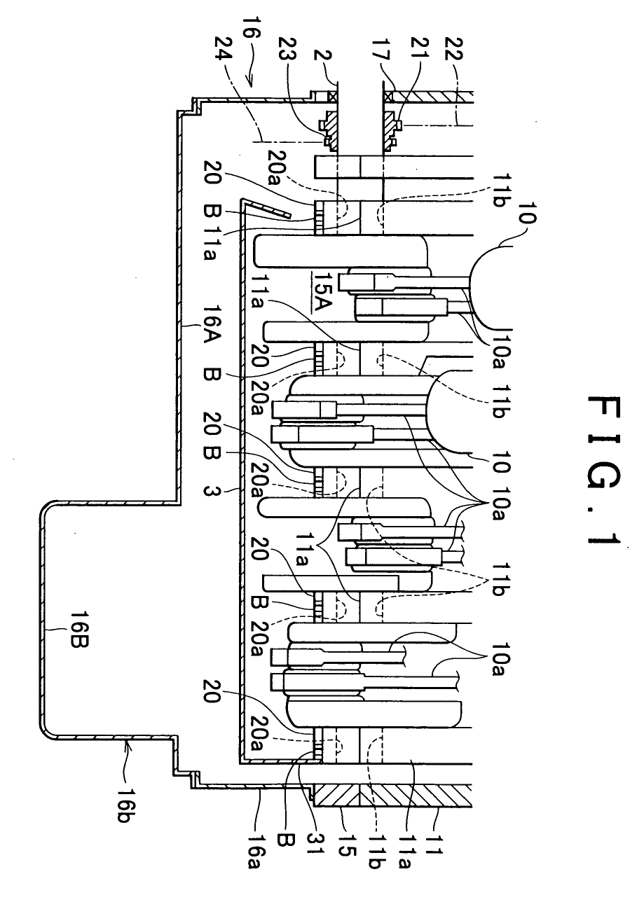

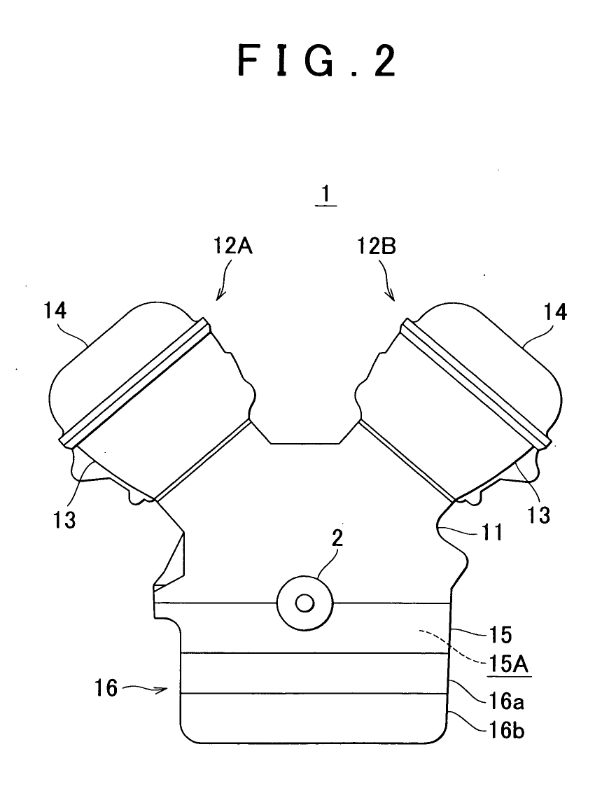

FIG. 1 is a cross-sectional view of a lower portion of a V-engine 1 as an internal combustion engine to which a baffle plate configuration according to the invention is applied. FIG. 1 is viewed from the side that is parallel to the axis of a crankshaft 2. FIG. 2 is a front view in which the V-engine 1 is viewed in the axial direction of the crankshaft 2.

As shown in FIG. 2, the V-engine 1 includes banks 12A and 12B that protrude upward from a cylinder block 11 to form a V shape. The banks 12A and 12B includes cylinder heads 13, 13 that are provided on the cylinder block 11, and head covers 14, 14 that are fixed at the upper ends of the cylinder heads 13, 13, respectively. Four cylinders are provided at a predetermined cylinder angle in each of the banks 12A, 12B. As shown in FIG. 1, each of pistons 10 (FIG. 1 shows only two of the pistons 10) is drivingly connected to the crankshaft 2 though connecting rods (rotational members) 10a. As shown in FIG. 2, a crankcase 15 is provided below the cylinder block 11, and a crank chamber 15A is defined by a space inside the crankcase 15. In this case, the gas that leaks from a gap between the cylinders and the pistons becomes blowby gas in the crank chamber 15A. This blowby gas and the pumping air generated by vertical movement of the pistons flow toward the front of the V-engine 1, because the inside space of the V-engine 1 is closed in the rear.

In the crank chamber 15A, crank journal supports 11a are formed at the lower ends of the cylinder block 11 at predetermined intervals in the axial direction of the crankshaft 2. The lower surface of each of the crank journal support 11a which is formed concave and thus has a semi-arc shape in cross section provides a concave portion 11b. Further, a crank cap 20 that has a concave portion 20a with a semi-arc shape in cross section is fixed to the lower face of each of the crank journal supports 11a with a volt B. The crankshaft 20 is rotatably supported between the concave portions 11b of the crank journal supports 11a and the concave portions 20a of the crank caps 20.

A pan 16 that serves as a sump is provided below the crankcase 15. The pan 16 is divided into an upper pan 16a, which is fixed to the lower end of the crankcase 15, and a lower pan 16b, which is fixed to the lower end of the upper pan 16a. A shallow depth portion 16A is provided in a front portion of the lower pan 16b. A deep depth portion 16B is provided in a rear portion of the lower pan 16b to store lubricant that returns to the pan 16. In this construction, the upper pan 16a is made of aluminum alloy, and the lower pan 16b is formed by pressing an iron plate. It should be noted, however, that materials used to form the upper pan 16a and the lower pan 16b are not limited to the combination described herein, and both of the upper and lower pans may be formed using the same material. Further, a pan made of magnesium alloy or the like may be used in combination of the upper and lower pans.

As shown in FIG. 1, in the front side of the crankshaft 2 (the left in FIG. 1), the crankshaft 2 protrudes forward past the front ends of the cylinder block 11 and the crankcase 15. A first crank sprocket 21 is coupled to the protruding portion of the crankshaft 2 so that they rotate together. A cam sprocket (not shown) is coupled to one end of a camshaft in each cylinder head 13 of each bank 12A and 12B so that the cam sprocket and the cam shaft rotate together. A timing chain 22 (chain) is wound around the first crank sprocket 21 and the cam sprockets. The first crank sprocket 21 rotates so that the cam sprockets are driven. Further, a second crank sprocket 23 is also coupled to the protruding portion of the crankshaft 2 so that they rotate together. The second crank sprocket 23 is located further to the crankcase 15 side (the right in FIG. 1) than is the first crank sprocket 21. A pump drive chain 24 is wound around the second crank sprocket 23 and a pump sprocket of the pump. The pump is driven by the pump sprocket being rotated by rotation of the second crank sprocket 23. In the front of the cylinder heads 13, the cylinder block 11, and the crankcase 15, a timing chain cover 17 made of aluminum alloy is attached to an upper edge of the front end of the upper pan 16a so that the timing chain 22 and the pump drive chain 24, which are located further forward than the front ends of the cylinder block 11 and the crankcase 15, are covered by the timing chain cover 17.

The front end of the crankshaft 2 is located further forward than the timing chain cover 17. A crankshaft pulley for driving accessories is also coupled to the front end of the crankshaft 2 so that the crankshaft pulley rotates together with the crankshaft 2.

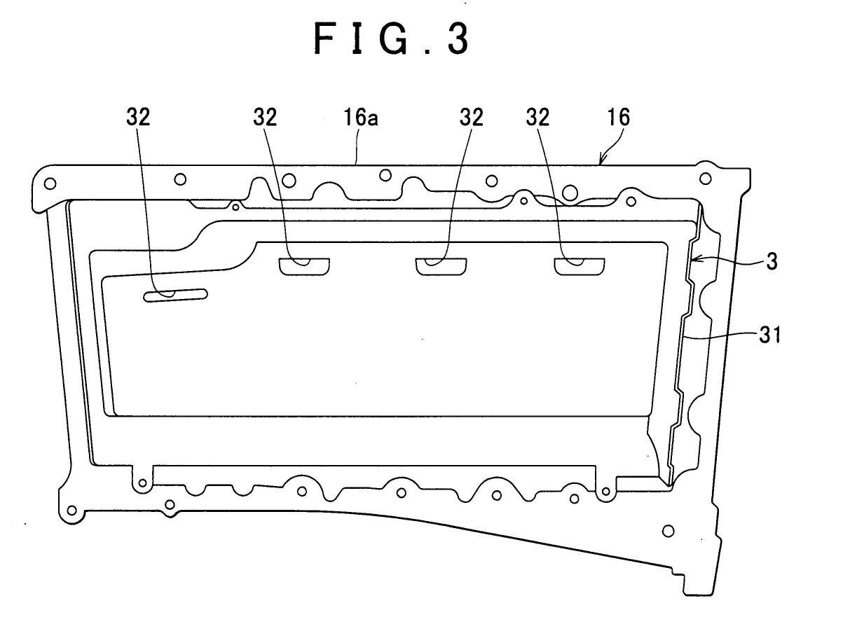

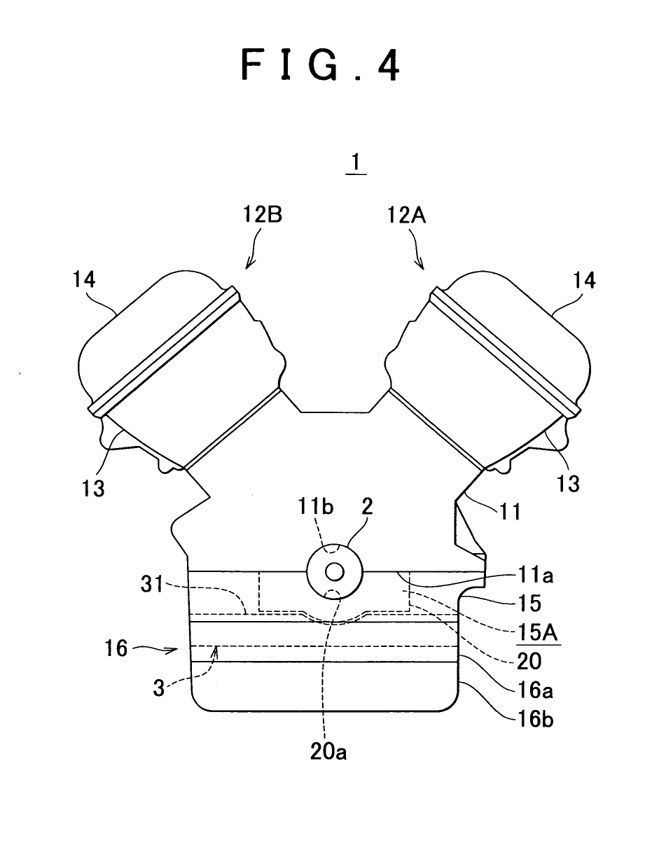

As shown in FIG. 3, a baffle plate 3 having a substantially flat shape is provided in the pan 16. The baffle plate 3 prevents interference between the rotational members provided on or near the crankshaft 2 and the lubricant in the pan. The baffle plate 3 is bolted to predetermined positions of the inner peripheral surface of the upper pan 16a. As shown in FIG. 4, an extending portion 31 is provided at the rear end of the baffle plate 3. The extending portion 31 extends upward so that its upper end is close to the rearmost crank cap 20 in the rear side of the crankshaft 2 (the right in FIG. 1)., i.e., the side in the axial direction of the crank shaft that is opposite to the side where a larger amount of lubricant returns to the pan 16. The extending portion 31 is provided as close to the crank cap 20 as possible while avoiding interference with the bolt B. The extending portion 31 serves as preventing means for preventing piston pumping air generated above the baffle plate 3 from entering the space below the baffle plate 3 through the rear end of the baffle plate 3. As shown in FIG. 1, the rear end of the baffle plate 3 from which the extending portion 31 extends upward is located in the side opposite to where the timing chain 22 and the pump drive chain 24 are provided, that is, in the side where the deep depth portion 16B is provided. In the rear of the rearmost crank cap 20, lubricant flows along a rear wall of the crankcase 15 and returns to the pan 16.

As shown in FIG. 3, return holes 32 are formed on the baffle plate 3 so that lubricant which has dropped to the baffle plate 3 returns to the pan 16.

In the aforementioned embodiment, the crank cap 20 at the rearmost position in the axial direction of the crankshaft 2 is in the side that is opposite, in the axial direction of the crankshaft 2, to the side where a larger amount of lubricant returns to the pan 16, that is, the side where the deep depth portion 16B is provided. In the rear of this rearmost crank cap 20, lubricant flows along the rear wall of the crankcase 15 and returns to the pan 16. Further, the extending portion 31, which extends upward to be in the proximity of the rearmost crank cap 20 from the rear end of the baffle plate 3, prevents piston pumping air generated above the baffle plate 3 from entering the space below the baffle plate 3 through the rear end of the baffle plate 3. According to this construction, a large amount of lubricant returning from the front side of the crankshaft 2 to the pan 16 through the baffle plate 3 is prevented from colliding with piston pumping air entering the pan 16 from the rear side of the crankshaft 2 through the rear end of the baffle plate 3. As a result, lubricant can smoothly return to the pan.

Accordingly, since collisions between piston pumping air and lubricant can be effectively prevented as described above, it is possible to reduce the height of the shallow depth portion 16A and thus the overall height of the V-engine 1, which is significantly desirable and advantageous in view of the protection of pedestrians and arrangement of accessories, for example. Moreover, since piston pumping air can be prevented from entering the pan, lubricant is not stirred by piston pumping air. Accordingly, lubricant can be prevented from being deteriorated, and a temperature increase of lubricant can also be prevented. In addition, the amount of lubricant which is atomized due to collision with piston pumping air and then carried away by the piston pumping air is reduced.

It should be noted, however, that the invention is not limited to this embodiment and includes various modifications. For example, in the embodiment, the extending portion 31 provided at the rear end of the baffle plate 3 extends upward to be in the proximity of the rearmost crank cap 20. Namely, the crank cap 20 towards which the extending portion 31 extends upward is located in the side that is opposite, in the axial direction of the crankshaft 2, to the following: the side where a larger amount of lubricant returns to the pan; the side where the timing chain 22 for transmitting rotation of the crankshaft 2 to cam shafts and the pump drive chain 24 are provided; and the side where the shallow depth portion 16A of the pan 6 is provided. For example, a crank cap towards which the extending portion of the baffle plate extends upward may be defined as follows: a crank cap located at the end of the crankshaft in the side that is opposite, in the axial direction of the crankshaft, to the side where a larger amount of lubricant returns to the pan; a crank cap located at the end of the crankshaft in the side that is opposite, in the axial direction of the crankshaft, to where a chain that transmits rotation of the crankshaft is provided; and a crank cap located at the end of the crankshaft located in the side that is opposite, in the axial direction of the crankshaft, to where a shallow depth portion of the pan is provided.

Further, in the embodiment above, in the crank chamber 15A, the crankshaft 2 is rotatably supported between the concave portions 11b of the crank journal supports 11a of the cylinder block 11 and the concave portions 20a of the crank caps 20. However, a ladder frame having concave portions may be used in place of the crank caps and the pan may be fixed to the lower end of the cylinder block via the ladder frame, so that the crankshaft is rotatably supported between the concave portions of the crank journal supports and the concave portions of the ladder frame. In this case, preventing means for preventing piston pumping air generated above the baffle plate from entering the space below the baffle plate through the rear end of the baffle plate may be formed by sandwiching the end portion of the baffle plate between the ladder frame and the pan where they are joined. For example, the end portion of the baffle plate to be sandwiched may be defined as follows: the end portion of the baffle plate located in the side that is opposite, in the axial direction of the crankshaft, to the side where a larger amount of lubricant returns to the pan; the end portion of the baffle plate located in the side that is opposite, in the axial direction of the crankshaft, to the side where the a chain for transmitting rotation of the crankshaft is provided; and the end portion of the baffle plate located in the side that is opposite, in the axial direction of the crankshaft, to the side where a shallow depth portion of the pan is provided.

Further, in the embodiment above, the baffle plate according to the invention is applied to the V-engine 1. However, the baffle plate may be applied to an in-line engine as well.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and constructions, which are exemplary, other combinations and constructions, including more, less or only single element, are also within the spirit and scope of the invention.

What is claimed is:

1. A baffle plate configuration of an internal combustion engine, comprising:
a baffle plate that is provided below a rotational member arranged on or near a crankshaft and prevents the rotational member and lubricant in a pan from interfering each other; and
a preventing portion that is provided at an end portion of the baffle plate located in a side in the axial direction of the crankshaft that is opposite to a side in the axial direction of the crankshaft where a larger amount of lubricant returns to the pan, and that prevents piston pumping air generated above the baffle plate from entering a space below the baffle plate through the end portion of the baffle plate.

2. The baffle plate configuration of an internal combustion engine according to claim 1, wherein:
the crankshaft is provided in a crankcase fixed to an upper end of the pan and is supported by a plurality of crank caps arranged in the axial direction of the crankshaft, and
the preventing portion is an extending portion that extends from the end portion of the baffle plate to be in the proximity of one of the crank caps which is located in the side opposite to the side where a larger amount of lubricant returns to the pan.

3. A baffle plate configuration of an internal combustion engine, comprising:
a baffle plate that prevents a rotational member arranged on or near a crankshaft and lubricant in a pan from interfering each other;
a chain that is provided in a side in an axial direction of the crankshaft and that transmits rotation of the crankshaft; and
a preventing portion that is provided at an end portion of the baffle plate located in a side in the axial direction of the crankshaft that is opposite to the side where the chain is provided, and that prevents piston pumping air generated above the baffle plate from entering a space below the baffle plate through the end portion of the baffle plate.

4. The baffle plate configuration of an internal combustion engine according to claim 3, wherein:
the crankshaft is provided in a crankcase fixed to an upper end of the pan and is supported by a plurality of crank caps arranged in the axial direction of the crankshaft, and
the preventing portion is an extending portion that extends from the end portion of the baffle plate to be in the proximity of one of the crank caps which is located in the side opposite to the side where the chain is provided.

5. A baffle plate configuration of an internal combustion engine, comprising:
a baffle plate that prevents a rotational member arranged on or near a crankshaft and lubricant in a pan from interfering each other;
a shallow depth portion that is provided in a side in an axial direction of the crankshaft and has a shallow depth; and
a preventing portion that is provided at an end portion of the baffle plate located in a side in the axial direction of the crankshaft that is opposite to the side where the shallow depth portion is provided, and that prevents piston pumping air generated above the baffle plate from entering a space below the baffle plate through the end portion baffle plate.

6. The baffle plate configuration of an internal combustion engine according to claim 5, wherein:
the crankshaft is provided in a crankcase fixed to an upper end of the pan and is supported by a plurality of crank caps arranged in the axial direction of the crankshaft, and
the preventing portion is an extending portion that extends from the end portion of the baffle plate to be in the proximity of one of the crank caps which is located in the side opposite to the side where the shallow depth portion is provided.

7. A baffle plate configuration of an internal combustion engine, comprising:
a baffle plate that is provided below a rotational member arranged on or near a crankshaft, and prevents the rotational member and lubricant in a pan from interfering each other; and
a preventing portion that is provided at an end portion of the baffle plate located in a side in an axial direction of the crankshaft that is opposite to a side in the axial direction of the crankshaft where the crankshaft protrudes from a crankcase that houses the rotational member, and that prevents piston pumping air generated above the baffle plate from entering a space below the baffle plate through the end portion of the baffle plate.

8. The baffle plate configuration of an internal combustion engine according to claim 7, wherein:
an amount of lubricant that returns to the pan in the side where the crankshaft protrudes from the cranks case is larger than an amount of lubricant that returns to the pan in the side opposite to the side where the crankshaft protrudes from the cranks case.

9. The baffle plate configuration of an internal combustion engine according to claim 8, wherein:
the crankshaft is provided in the crankcase fixed to an upper end of the pan and is supported by a plurality of crank caps arranged in the axial direction of the crankshaft, and
the preventing portion is an extending portion that extends from the end portion of the baffle plate to be in the proximity of one of the crank caps which is located in the side opposite to the side where the crankshaft protrudes from the cranks case.

10. The baffle plate configuration of an internal combustion engine according to claim 7, wherein:
a chain that transmits rotation of the crankshaft is provided in the side where the crankshaft protrudes from the crankcase.

11. The baffle plate configuration of an internal combustion engine according to claim 10, wherein:
the crankshaft is provided in the crankcase fixed to an upper end of the pan and is supported by a plurality of crank caps arranged in the axial direction of the crankshaft, and
the preventing portion is an extending portion that extends from the end portion of the baffle plate to be in the proximity of one of the crank caps which is located in the side where the preventing portion is provided.

12. The baffle plate configuration of an internal combustion engine according to claim 7, wherein:
a shallow depth portion whose depth is shallow is provided in the side where the crankshaft protrudes from the crankcase.

13. The baffle plate configuration of an internal combustion engine according to claim 12, wherein:
the crankshaft is provided in the crankcase is fixed to an upper end of the pan and is supported by a plurality of crank caps arranged in the axial direction of the crankshaft, and
the preventing portion is an extending portion that extends from the end portion of the baffle plate to be in the proximity of one of the crank caps which is located in the side where the preventing portion is provided.
